(19) United States
(12) Patent Application Publication
(10) Pub. No.: US 2025/0113247 A1
(43) Pub. Date: Apr. 3, 2025

(54) WIRELESS COMMUNICATION METHOD AND DEVICES THEREOF

(71) Applicant: ZTE Corporation, Shenzhen (CN)

(72) Inventors: Xiubin SHA, Shenzhen (CN); He HUANG, Shenzhen (CN); Bo DAI, Shenzhen (CN); Yuan GAO, Shenzhen (CN); Eswar Kalyan VUTUKURI, Shenzhen (CN)

(21) Appl. No.: 18/979,134

(22) Filed: Dec. 12, 2024

Related U.S. Application Data
(63) Continuation of application No. PCT/CN2022/141614, filed on Dec. 23, 2022.

(51) Int. Cl. H04W 28/02

(52) U.S. Cl. CPC H04W 28/0278

(57) ABSTRACT

A wireless communication method for use in a wireless terminal is disclosed. The method comprises transmitting, to a wireless network node, a baseline buffer size report (BSR) and supplemental information, wherein report information reported by the BSR is determined based on baseline information indicated by the baseline BSR and the supplemental information.

### CROSS-REFERENCE TO RELATED APPLICATIONS

This application is a continuation of International Patent Application No. PCT/CN2022/141614, filed on Dec. 23, 2022, the disclosure of which is incorporated herein by reference in its entirety.

### TECHNICAL FIELD

This document is directed generally to wireless communications, and in particular to 5G communications.

### BACKGROUND

There are two existing BSR (Buffer Size Report) tables which are used by a UE (user equipment) for BSR reporting, wherein one table is 5-bit Buffer Size field used when the short BSR is triggered and another table is 8-bit Buffer Size field used for long BSR reporting. In both BSR tables, the larger the index is, the larger the buffer size value granularity becomes. In other words, the higher the index is, the larger the quantization error becomes. The XR (extended reality) services usually have a large packet size and the existing BSR tables are not efficient for the XR services.

In addition, the following procedure may be used for UL (uplink) packet delivery:
UE reporting the buffer size level (e.g., reporting the UL packets amount in the UE buffer by a BSR MAC (media access control) CE (control element)) to a radio network element;
radio network element allocates a UL grant for the UE based on the BSR reports and the AN PDB (Access Network Packet Delay Budget); and
UE sending the UL packets over the allocated UL grant.

Based on the above procedure, when the radio network element allocates the UL grant for the UE, the radio network element cannot acknowledge how long the UL packet is buffered and how much remaining AN PDB (access network packet delay budget) can be used for the transmission when receiving the BSR. If the radio network element allocates the UL grant based on only the AN PDB (e.g., not considering the time duration that the UL packet is buffered in the UE), the UL packet transmission delay (e.g., the delay between the packet arriving the UE PDCP and the packet arriving to the radio network element) may exceed the AN PDB and the UL transmission cannot satisfy the service requirements. Therefore, further discussions on how to report the BSR are required.

### SUMMARY

This document relates to methods, systems, and devices for BSR and in particularly to methods, systems and devices for BSR with a fine granularity.

The present disclosure relates to a wireless communication method for use in a wireless terminal. The method comprises:
transmitting, to a wireless network node, a baseline buffer size report (BSR) and supplemental information, wherein report information reported by the BSR is determined based on baseline information indicated by the baseline BSR and the supplemental information

Various embodiments may preferably implement the following features:

Preferably, the supplemental information is preceding or following the baseline BSR.

Preferably, the supplement information comprises at least one of supplemental buffer size information associated with a baseline buffer size indicated by the baseline BSR or supplemental time information associated with baseline time information indicated by the baseline BSR, wherein the baseline time information is associated with a period of the baseline buffer size being cached in the wireless terminal.

Preferably, the supplemental information shares at least one logic channel identifier or at least one logic channel group identifier of the baseline BSR.

Preferably, the report information is determined to be equal to a sum of the baseline information and the supplemental information. More preferably, the report information is a buffer size.

Preferably, the baseline information is a minimum value of a baseline information range corresponding to a baseline information index indicated by the baseline BSR.

Preferably, the report information is determined to be equal to a difference between the baseline information and the supplemental information. More preferably, the report information is a buffer size.

Preferably, the baseline information is a maximum value of a baseline information range corresponding to a baseline information index indicated by the baseline BSR.

Preferably, the supplemental information is determined based on a result of a function of a supplemental information index and a supplemental information value step.

Preferably, the function of the supplemental information index and the supplemental information value step is:
(supplemental information index×supplemental information value step), or
(supplemental information value step to the power of supplemental information index).

Preferably, the supplemental indicates the supplemental information index.

Preferably, the supplemental information value step is determined based on a baseline information range indicated by a baseline information index in the baseline BSR and a number of values corresponding to the supplemental information.

Preferably, the supplemental information indicates the supplemental information index and the supplemental information value step.

Preferably, the supplemental information is equal to a smaller value between:
the function of the supplemental information index and the supplemental information value step, and
a difference between a maximal value of the baseline information indicated by a baseline information index in the baseline BSR and a minimum value of the baseline information indicated by the baseline information index in the baseline BSR.

Preferably, the baseline BSR is one of a Short BSR, a Short Truncated BSR, an Extended Short BSR, an Extended Short Truncated BSR, a Long BSR, a Long Truncated BSR, a Pre-emptive BSR, an Extended Long BSR, an Extended Long Truncated BSR, or an Extended Pre-emptive BSR.

Preferably, the wireless communication method further comprises receiving, from the wireless network node, an indication associated with supporting or activating the supplemental information.

Preferably, the wireless communication method further comprises receiving, from the wireless network node, a quantization error threshold. More preferably, the supplemental information is transmitted if a quantization error associated with the report information is greater than the threshold.

The present disclosure relates to a wireless communication method for use in a wireless network node. The method comprises:
receiving, from a wireless terminal, a baseline buffer size report (BSR) and supplemental information, and
determining report information based on baseline information indicated by the baseline BSR and the supplemental information.

Various embodiments may preferably implement the following features:

Preferably, the supplemental information is preceding or following the baseline BSR.

Preferably, the supplement information comprises at least one of supplemental buffer size information associated with a baseline buffer size indicated by the baseline BSR or supplemental time information associated with baseline time information indicated by the baseline BSR, wherein the baseline time information is associated with a period of the baseline buffer size being cached in the wireless terminal.

Preferably, the supplemental information shares at least one logic channel identifier or at least one logic channel group identifier of the baseline BSR.

Preferably, determining the report information based on the baseline information indicated by the baseline BSR and the supplemental information comprises:

determining a sum of the baseline information and the supplemental information as the report information. More preferably, the report information is a buffer size.

Preferably, the baseline information is a minimum value of a baseline information range corresponding to a baseline information index indicated by the baseline BSR.

Preferably, determining the report information based on the baseline information indicated by the baseline BSR and the supplemental information comprises:

determining a difference between the baseline information and the supplemental information as the report information. More preferably, the report information is a buffer size.

Preferably, the baseline information is a maximum value of a baseline information range corresponding to a baseline information index indicated by the baseline BSR.

Preferably, the supplemental information is determined based on a result of a function of a supplemental information index and a supplemental information value step.

Preferably, the function of the supplemental information index and the supplemental information value step is:
(supplemental information index×supplemental information value step), or
(supplemental information value step to the power of supplemental information index).

Preferably, the supplemental BSR indicates the supplemental BSR information index.

Preferably, the supplemental information value step is determined based on a baseline information range indicated by a baseline information index in the baseline BSR and a number of values corresponding to the supplemental information.

Preferably, the supplemental information indicates the supplemental information index and the supplemental information value step.

Preferably, the supplemental information is equal to a smaller value between:
the function of the supplemental information index and the supplemental information value step, and
a difference between a maximal value of the baseline information indicated by a baseline information index in the baseline BSR and a minimum value of the baseline information indicated by the baseline information index in the baseline BSR.

Preferably, the baseline BSR is one of a Short BSR, a Short Truncated BSR, an Extended Short BSR, an Extended Short Truncated BSR, a Long BSR, a Long Truncated BSR, a Pre-emptive BSR, an Extended Long BSR, an Extended Long Truncated BSR, or an Extended Pre-emptive BSR.

Preferably, the wireless communication method further comprises transmitting, to the wireless terminal, an indication associated with supporting or activating the supplemental information.

Preferably, the wireless communication method further comprises transmitting, to the wireless terminal, a quantization error threshold associated with transmitting the supplemental information.

The present disclosure relates to a wireless communication method for use in a wireless terminal, the method comprising:
transmitting, to a wireless network node, a dynamic buffer size report (BSR),
wherein a buffer size indicated by the dynamic BSR is determined by:

buffer size=minimal buffer size value+buffer size value step size×buffer size value sequence number.

Various embodiments may preferably implement the following features:

Preferably, the dynamic BSR comprises at least one of the minimal buffer size value, the buffer size value step size or the buffer size value sequence number.

Preferably, the dynamic BSR further comprises an indication of whether the dynamic BSR comprises a time information field.

Preferably, the time information field indicates a time of the buffer size is cached in the wireless terminal.

The present disclosure relates to a wireless communication method for use in a wireless network node, the method comprising:
receiving, from a wireless terminal, a dynamic buffer size report (BSR), and
determining a buffer size indicated by the dynamic BSR by:

buffer size=minimal buffer size value+buffer size value step size×buffer size value sequence number.

Various embodiments may preferably implement the following features:

Preferably, the dynamic BSR comprises at least one of the minimal buffer size value, the buffer size value step size or the buffer size value sequence number.

Preferably, the dynamic BSR further comprises an indication of whether the dynamic BSR comprises a time information field.

Preferably, the time information field indicates a time of the buffer size is cached in the wireless terminal.

The present disclosure relates to a wireless terminal. The wireless terminal comprises:
a communication unit, configured to transmit, to a wireless network node, a baseline buffer size report (BSR) and supplemental information, wherein report information reported by the BSR is determined based on baseline information indicated by the baseline BSR and the supplemental information.

Various embodiments may preferably implement the following feature:

Preferably, the wireless terminal further comprises a processor configured to perform any of aforementioned wireless communication methods.

The present disclosure relates to a wireless network node. The wireless network node comprises:
a communication unit, configured to receive, from a wireless terminal, a baseline buffer size report (BSR) and supplemental information, and
a processor, configured to determine report information based on baseline information indicated by the baseline BSR and the supplemental information.

Various embodiments may preferably implement the following feature:

Preferably, the processor is further configured to perform any of the aforementioned wireless communication methods.

The present disclosure relates to a wireless terminal. The wireless terminal comprises:
a communication unit, configured to transmit, to a wireless network node, a dynamic buffer size report (BSR),
wherein a buffer size indicated by the dynamic BSR is determined by:

buffer size=minimal buffer size value+buffer size value step size×buffer size value sequence number.

Various embodiments may preferably implement the following feature:

Preferably, the wireless terminal further comprises a processor configured to perform any of aforementioned wireless communication methods.

The present disclosure relates to a wireless network node. The wireless network node comprises:
a communication unit, configured to receive, from a wireless terminal, a dynamic buffer size report (BSR), and
a processor, configured to determine a buffer size indicated by the dynamic BSR by:

buffer size=minimal buffer size value+buffer size value step size×buffer size value sequence number.

Various embodiments may preferably implement the following feature:

Preferably, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a media access control (MAC) control element (CE) according to an embodiment of the present disclosure.

FIG. 2 shows a schematic diagram of a supplemental Short BSR and Short Truncated BSR MAC CE according to an embodiment of the present disclosure.

FIG. 3 shows a schematic diagram of a baseline Short BSR and Short Truncated BSR MAC CE may be a legacy Short BSR and Short Truncated BSR MAC CE according to an embodiment of the present disclosure.

FIG. 4 shows a schematic diagram of an Extended Short BSR and Extended Short Truncated BSR MAC CE according to an embodiment of the present disclosure.

FIG. 5 shows a table of buffer size levels according to an embodiment of the present disclosure.

FIG. 6 shows a schematic diagram of a supplemental Long BSR, Long Truncated BSR, and Pre-emptive BSR MAC CE according to an embodiment of the present disclosure.

FIG. 7 shows a schematic diagram of a baseline Long BSR, Long Truncated BSR, and Pre-emptive BSR MAC CE according to an embodiment of the present disclosure.

FIG. 8 shows a schematic diagram of a supplemental Extended Long BSR, Long Truncated BSR, and Pre-emptive BSR MAC CE according to an embodiment of the present disclosure.

FIG. 9 shows a schematic diagram of a baseline Extended Long BSR, Long Truncated BSR, and Pre-emptive BSR MAC CE according to an embodiment of the present disclosure.

FIG. 10 shows a schematic diagram of a supplemental Long BSR, Long Truncated BSR, and Pre-emptive BSR MAC CE according to an embodiment of the present disclosure.

FIGS. 11 to 17 show schematic diagrams of time information MAC CEs according to embodiments of the present disclosure.

FIG. 18 shows an example of a schematic diagram of a wireless terminal according to an embodiment of the present disclosure.

FIG. 19 shows an example of a schematic diagram of a wireless network node according to an embodiment of the present disclosure.

FIG. 20 shows a schematic diagram of a wireless communication system according to an embodiment of the present disclosure.

FIGS. 21 to 24 show flowcharts of methods according to embodiments of the present disclosure.

### DETAILED DESCRIPTION

### Dynamic BSR Table

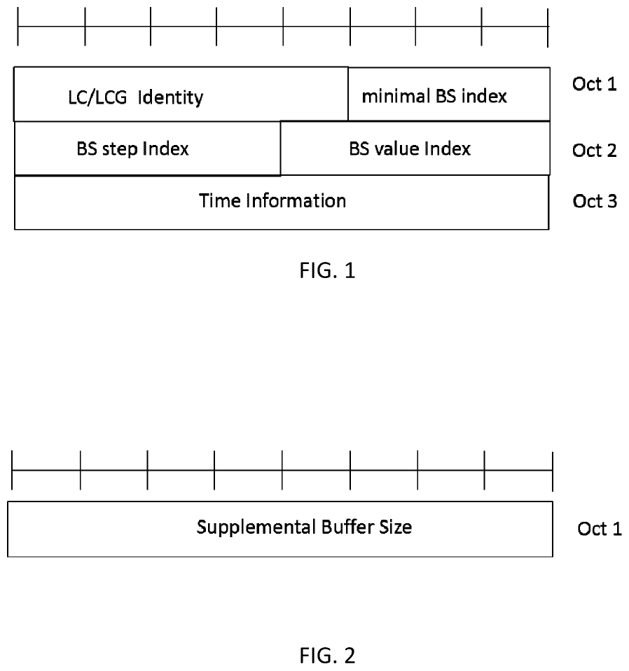

FIG. 1 shows a schematic diagram of a UL data volume in a UE buffer (Buffer Size, BS) reporting MAC CE according to an embodiment of the present disclosure. The MAC CE shown in FIG. 1 comprises at least one of the following fields: Logical Channel (LC) Identity, Logical Channel Group (LCG) Identity, minimal buffer size index, buffer size step Index, buffer size value Index, a time indication and Time Information.

In an embodiment, if the LC Identity is included, the BSR is reported for the LC ID.

In an embodiment, if the LCG Identity is included, the BSR is reported for the logical channel ID.

In an embodiment, the minimal buffer size index is used to determine the minimal buffer size value.

In an embodiment, the buffer size step Index is used to determine the buffer size value step size.

In an embodiment, the buffer size value sequence Index is used to determine the buffer size value sequence number.

In an embodiment, the reported buffer size value reported=minimal buffer size value+buffer size value step size*buffer size value sequence number.

In an embodiment, the time indication (TI) is used to indicate whether the time information field is present in the MAC CE. For example, the TI may be 1 bit field. If TI=0, the MAC CE comprises only two Oct (i.e., there is not time information field). If TI=1, the MAC CE has three Oct and there is time information field.

In an embodiment, the Time Information field is configured to identify the time that the Buffer Size is cached in UE. For example, the Time Information field may include at least one of: elapsed time since the packet(s) arrives at UE PDCP or PDCP upper SAP; the remaining time before the elapsed time since the packet(s) arrives at UE PDCP or PDCP upper SAP reaches the (AN) Packet delay budget; the remaining time before the packet discardTimer expires; the arriving time that the packet(s) arrives at UE PDCP or PDCP upper SAP; an immediate scheduling indication indicates whether the packet(s) corresponding to the buffer size should be scheduled or transmitted immediately; a scheduling priority indication indicates whether the PDU set(s) corresponding to the buffer size should be scheduled or transmitted with the indicated priority.

Note that the bits number of each field in the MAC CE shown in FIG. 1 is only an exemplified embodiment. The bits number of each field can be different from that shown in FIG. 1. Moreover, the oct number shown in FIG. 1 is also used for illustration purpose. The oct number less or more oct may be used per MAC CE.

In an embodiment, the UL data volume in the UE buffer (Buffer Size, BS) reporting MAC CE is identified by a pre-defined UL LC ID in a MAC subheader.

In an embodiment, before UE sends UL data volume in UE buffer (Buffer Size, BS) reporting MAC CE, the UE receives, from a radio access network (RAN) node (e.g., gNB), an indication on whether the RAN node supports to decode the UL data volume in UE buffer (Buffer Size, BS) reporting MAC CE.

In an embodiment, the RAN node sends the indication over SIB (system information block) or an RRC (radio resource control) dedicated signaling.

### Supplemental BSR MAC CE

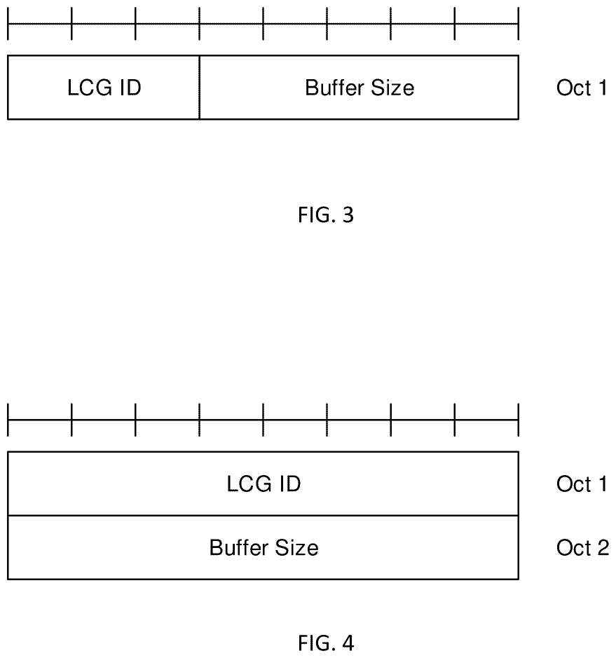

FIG. 2 shows a schematic diagram of a supplemental Short BSR and Short Truncated BSR MAC CE according to an embodiment of the present disclosure. As shown in FIG. 2, the supplemental buffer size value level is included in the MAC CE. In an embodiment, the supplemental Short BSR and Short Truncated BSR MAC CE is sent with a baseline Short BSR and Short Truncated BSR MAC CE or Extended baseline Short BSR and Extended Short Truncated BSR MAC CE. For example, the baseline Short BSR and Short Truncated BSR MAC CE may be one of a legacy Short BSR and Short Truncated BSR MAC CE shown in FIG. 3 and the Extended baseline Short BSR and Extended Short Truncated BSR MAC CE may be a legacy Extended Short BSR and Extended Short Truncated BSR MAC CE shown in FIG. 4.

In the present disclosure, the Short BSR and Short Truncated BSR MAC CE refers to a Short BSR MAC CE or a Short Truncated BSR MAC CE. In addition, the Short BSR MAC CE means a BSR MAC CE in a Short BSR format. The Short Truncated BSR MAC CE means a BSR MAC CE in a Short Truncated BSR format.

Similarly, the Extended Short BSR and Extended Short Truncated BSR MAC CE refers to an Extended Short BSR MAC CE or an Extended Short Truncated BSR MAC CE. The Extended Short BSR MAC CE means a BSR MAC CE in an Extended Short BSR format. The Extended Short Truncated BSR MAC CE means a BSR MAC CE in an Extended Short Truncated BSR format.

In an embodiment, the buffer size reported for the LCG ID equal to the sum of the buffer size for the LCG ID in the baseline (Extended) Short BSR and Short Truncated BSR MAC CE plus the supplemental buffer size for the LCG ID in the supplemental Short BSR and Short Truncated BSR MAC CE. In this embodiment, the buffer size in the baseline (Extended) Short BSR and Short Truncated BSR MAC CE is/indicates the minimal Buffer size value indicated by a buffer size index for the LCG ID in the baseline (Extended) Short BSR and Short Truncated BSR MAC CE.

In an embodiment, the buffer size reported for the LCG ID equal to the sum of the buffer size for the LCG ID in the baseline (Extended) Short BSR and Short Truncated BSR MAC CE minus the supplemental buffer size for the LCG ID in the supplemental Short BSR and Short Truncated BSR MAC CE. In this embodiment, the buffer size in the baseline (Extended) Short BSR and Short Truncated BSR MAC CE is indicates the maximum Buffer size value indicated by a buffer size index for the LCG ID in the baseline (Extended) Short BSR and Short Truncated BSR MAC CE.

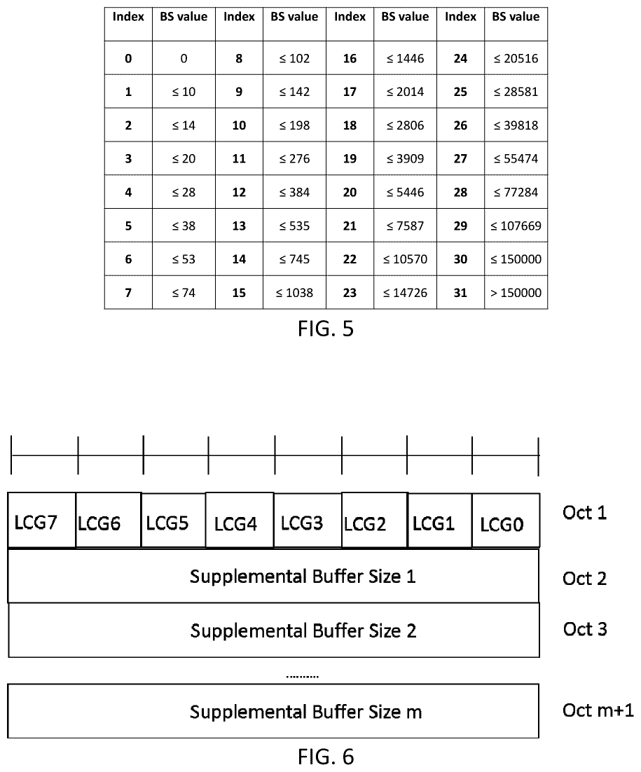

FIG. 5 shows a table of buffer size levels according to an embodiment of the present disclosure. In an embodiment, the baseline (Extended) Short BSR and Short Truncated BSR MAC CE indicates the buffer size index 22 for an LCG ID, where the buffer size index 22 is corresponding to a buffer size value range from 7588 to 10570.

In this embodiment, if a supplemental Short BSR and Short Truncated BSR MAC CE is sent with (e.g., preceding or following) the baseline (Extended) Short BSR and Short Truncated BSR MAC CE, the buffer size value indicated by the baseline (Extended) Short BSR and Short Truncated BSR MAC CE for the LCG ID corresponds to the minimal buffer size value in the buffer size range (i.e., 7588). The buffer size reported for the LCG ID=7588+the supplemental buffer size in the supplemental Short BSR and Short Truncated BSR MAC CE.

As an alternative, when/if the supplemental Short BSR and Short Truncated BSR MAC CE is sent with the baseline (Extended) Short BSR and Short Truncated BSR MAC CE, the buffer size value indicated by the baseline (Extended) Short BSR and Short Truncated BSR MAC CE for the LCG ID corresponds to the maximal buffer size value in the buffer size range (i.e., 10570). The buffer size reported for the LCG ID=10570−the supplemental buffer size in the supplemental Short BSR and Short Truncated BSR MAC CE.

The supplemental buffer size reported in the supplemental Short BSR and Short Truncated BSR MAC CE may be determined by one of the following embodiments.

In an embodiment, a supplemental buffer size index is included in the supplemental Short BSR and Short Truncated BSR MAC CE and a value step of the supplemental buffer size is calculated based on the buffer size value range corresponding to a buffer size index in the baseline Short BSR and Short Truncated BSR MAC CE. In this embodiment, the value of supplemental buffer size reported in the supplemental Short BSR and Short Truncated BSR MAC CE is determined by:
the value step of supplemental buffer size=round((the maximal value of buffer size value range for the buffer size index−the minimal value of buffer size value range for the buffer size index)/value number of supplemental buffer size); and
the value of the supplemental buffer size=minimal (the value step of supplemental buffer size*the index of the supplemental buffer size in the supplemental Short BSR and Short Truncated BSR MAC CE, the maximal value of buffer size value range for the buffer size index−minimal value of buffer size value range for the buffer size index).

Note that Round(x) is a function of acquiring an integer nearest to x. For example, Round(x) can also be substituted by ceil(x) or floor(x), wherein the ceil(x) is a function of acquiring a least/smallest integer larger than or equal to x, and the floor(x) is a function of acquiring a largest integer smaller than or equal to x.

In an embodiment, the value step of the supplemental buffer size and the supplemental buffer size index are included in the supplemental Short BSR and Short Truncated BSR MAC CE. In this embodiment, the supplemental Short BSR reported/indicated by the supplemental Short BSR and Short Truncated BSR MAC CE is determined by:
the value of the supplemental buffer size=minimal (the value step of supplemental buffer size*the index of the supplemental buffer size in the supplemental Short BSR and Short Truncated BSR MAC CE, the maximal value of buffer size value range for the buffer size index−minimal value of buffer size value range for the buffer size index).

In an embodiment, the value step of supplemental buffer size and/or the supplemental buffer size index is pre-defined. In this embodiment, the supplemental Short BSR reported/indicated by the supplemental Short BSR and Short Truncated BSR MAC CE is determined by:
the value of the supplemental buffer size=function(the value step of supplemental buffer size and/or the supplemental buffer size index),
wherein function(x, y) is pre-defined.

For example, if the value step of supplemental buffer size=2 and the supplemental buffer size index is an integer n, the value of supplemental buffer size=2*n or the value of the supplemental buffer size=2\hat{ }n. That is function(x, y) may be x*y or x^{y}.

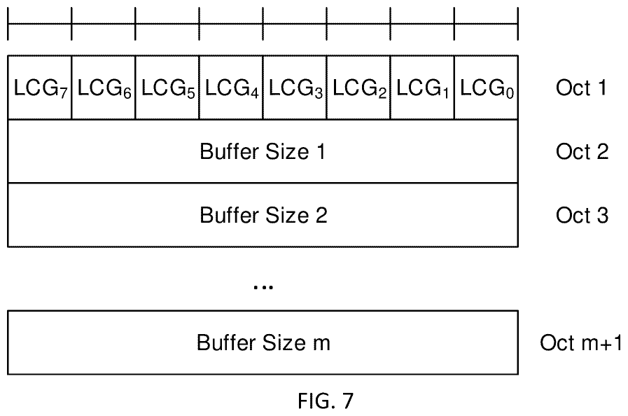

FIG. 6 shows a schematic diagram of a supplemental Long BSR, Long Truncated BSR, and Pre-emptive BSR MAC CE according to an embodiment of the present disclosure. The supplemental Long BSR, Long Truncated BSR, and Pre-emptive BSR MAC CE may be transmitted with a baseline Long BSR, Long Truncated BSR, and Pre-emptive BSR MAC CE shown in FIG. 7.

In the present disclosure, the Long BSR, Long Truncated BSR, and Pre-emptive BSR MAC CE refers to a Long BSR MAC CE, a Long Truncated BSR MAC CE or a Pre-emptive BSR MAC CE. The Long BSR MAC CE represents a BSR MAC CE in a Long BSR format. The Long Truncated BSR MAC CE represents a BSR MAC CE in a Long Truncated BSR format. The Pre-emptive BSR MAC CE represents a BSR MAC CE in a Pre-emptive BSR format.

In an embodiment of FIG. 6 and FIG. 7, the buffer size reported for a LCG ID (e.g., LCG0) equal to the sum of the corresponding baseline buffer size for the LCG ID in the baseline Long BSR, Long Truncated BSR, and Pre-emptive BSR MAC CE plus the corresponding supplemental buffer size for the LCG ID in the supplemental Long BSR, Long Truncated BSR, and Pre-emptive BSR MAC CE. In this embodiment, the corresponding baseline buffer size in the baseline Long BSR, Long Truncated BSR, and Pre-emptive BSR MAC CE is the minimum Buffer size value indicated by the buffer size index for the LCG ID.

In an embodiment, the buffer size reported for a LCG ID equal to the sum of the corresponding baseline buffer size for the LCG ID in the baseline Long BSR, Long Truncated BSR, and Pre-emptive BSR MAC CE minus the corresponding supplemental buffer size for the LCG ID in the supplemental Long BSR, Long Truncated BSR, and Pre-emptive BSR MAC CE. In this embodiment, the baseline buffer size in the baseline Long BSR, Long Truncated BSR, and Pre-emptive BSR MAC CE is the maximum Buffer size value indicated by the baseline buffer size index for the LCG ID.

Note that, the determination of the supplemental buffer size in the supplemental Long BSR, Long Truncated BSR, and Pre-emptive BSR MAC CE can be done as the determination of the supplemental buffer size in the supplemental Short BSR and Short Truncated BSR MAC CE.

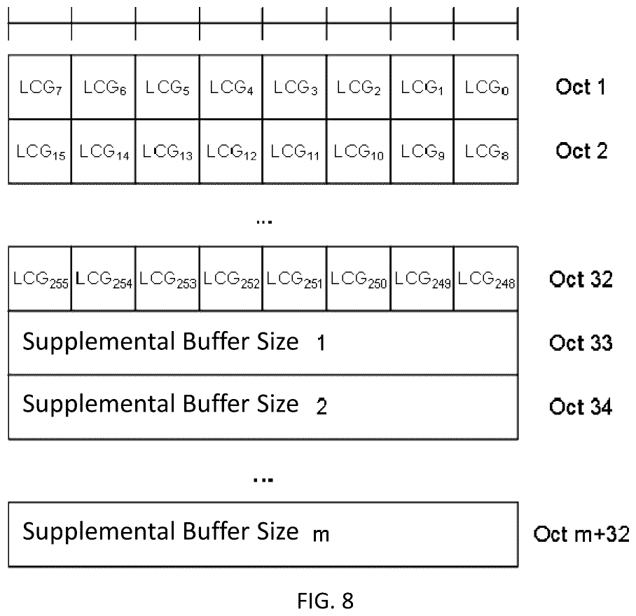

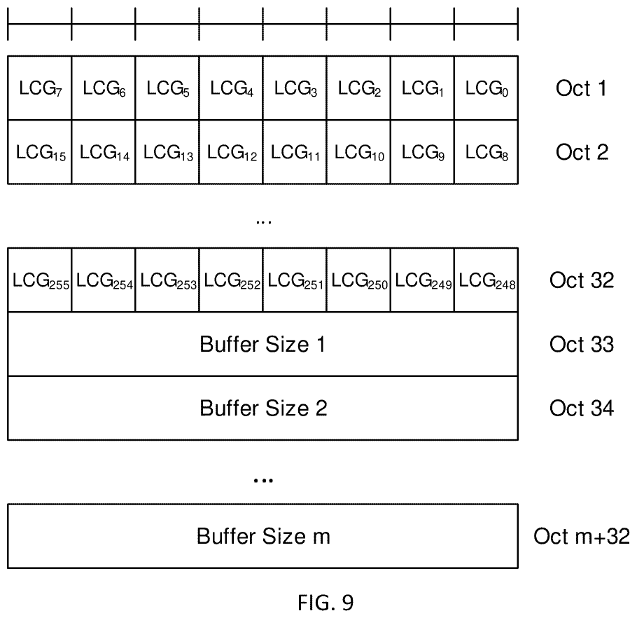

FIG. 8 shows a schematic diagram of a supplemental Extended Long BSR, Long Truncated BSR, and Pre-emptive BSR MAC CE according to an embodiment of the present disclosure. In an embodiment, the supplemental Extended Long BSR, Long Truncated BSR, and Pre-emptive BSR MAC CE follows or precedes a baseline Extended Long BSR, Long Truncated BSR, and Pre-emptive BSR MAC CE shown in FIG. 9.

In the present disclosure, the Extended Long BSR, Long Truncated BSR, and Pre-emptive BSR MAC CE refers to an Extended Long BSR MAC CE, an Extended Long Truncated BSR MAC CE or an Extended Pre-emptive BSR MAC CE. The Extended Long BSR MAC CE represents a BSR MAC CE in an Extended Long BSR format. The Extended Long Truncated BSR MAC CE represents a BSR MAC CE in an Extended Long Truncated BSR format. The Extended Pre-emptive BSR MAC CE represents a BSR MAC CE in an Extended Pre-emptive BSR format.

In an embodiment, the buffer size reported for an LCG ID is equal to the sum of the corresponding baseline buffer size for the LCG ID in the baseline Extended Long BSR, Extended Long Truncated BSR, and Extended Pre-emptive BSR MAC CE plus the corresponding supplemental buffer size for the LCG ID in the supplemental Extended Long BSR, Extended Long Truncated BSR, and Extended Pre-emptive BSR MAC CE. In this embodiment, the baseline buffer size in the Extended Long BSR, Extended Long Truncated BSR, and Extended Pre-emptive BSR MAC CE is the minimum Buffer size value indicated by the buffer size index for the LCG ID.

In an embodiment, the buffer size reported for an LCG ID is equal to the result of the corresponding baseline buffer size for the LCG ID in the baseline Extended Long BSR, Extended Long Truncated BSR, and Extended Pre-emptive BSR MAC CE minus the corresponding supplemental buffer size for the LCG ID in the supplemental Extended Long BSR, Extended Long Truncated BSR, and Extended Pre-emptive BSR MAC CE. In this embodiment, the baseline buffer size in the Extended Long BSR, Extended Long Truncated BSR, and Extended Pre-emptive BSR MAC CE indicates the maximal Buffer size value indicated by the buffer size index for the LCG ID.

Note that, the determination of the supplemental buffer size in the supplemental Extended Long BSR, Extended Long Truncated BSR, and Extended Pre-emptive BSR MAC CE can be done as the determination of the supplemental buffer size in the supplemental Short BSR and Short Truncated BSR MAC CE.

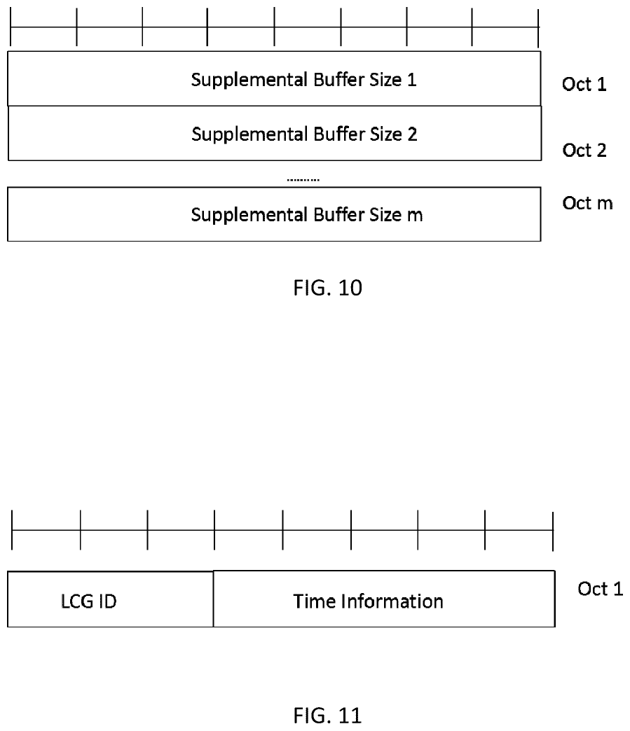

FIG. 10 shows a schematic diagram of a supplemental Long BSR, Long Truncated BSR, and Pre-emptive BSR MAC CE according to an embodiment of the present disclosure. The supplemental Long BSR, Long Truncated BSR, and Pre-emptive BSR MAC CE shown in FIG. 10 may follow or precede the baseline Long BSR, Long Truncated BSR, and Pre-emptive BSR MAC CE (e.g., FIG. 7) or an Extended Long BSR, Long Truncated BSR, and Pre-emptive BSR MAC CE (e.g., FIG. 9).

The supplemental Long BSR, Long Truncated BSR, and Pre-emptive BSR MAC CE shown in FIG. 10 is different from that shown in FIG. 6 or 8 in that the supplemental Long BSR, Long Truncated BSR, and Pre-emptive BSR MAC CE shown in FIG. 10 does not comprise the LCG IDs. The supplemental buffer size x (x=1, 2, . . . , or m) in the supplemental Long BSR, Long Truncated BSR, and Pre-emptive BSR MAC CE is corresponding to the buffer size x (x=1, 2, . . . , or m) in the baseline Long BSR, Long Truncated BSR, and Pre-emptive BSR MAC CE (e.g., FIG. 7) or the baseline Extended Long BSR, Long Truncated BSR, and Pre-emptive BSR MAC CE (e.g., FIG. 9). That is the supplemental buffer size x in FIG. 10 and the buffer size x in FIG. 7 or 9 corresponds to the same LCG ID (e.g., the buffer size of the corresponding LCG is the sum of the supplemental buffer size x for the LCG ID in FIG. 10 and the buffer size x for the LCG ID in FIG. 7 or 9).

In an embodiment, the Supplement BSR MAC CE shown in FIG. 10 is identified by a pre-defined UL LC ID in a MAC subheader.

In an embodiment, before the UE sends the Supplement BSR MAC CE, the UE receives, from gNB, at least one of an indication of whether the gNB supports the Supplement BSR MAC CE, an indication of activating the Supplement BSR MAC CE report, or a threshold associated with sending the Supplement BSR MAC CE. The gNB may send the indication(s) or the threshold over SIB (system information block) or an RRC dedicated signaling (e.g. configured per UE, per LCG, Per logical channel, per RLC configuration or per DRB in the RRC dedicated signaling). In an embodiment, the Supplement BSR MAC CE can be sent (only) if the UE receives the indication of the gNB supporting the Supplement BSR MAC CE, the UE receives the indication of activating the Supplement BSR MAC CE report, or a quantization error is larger than the threshold associated with sending the Supplement BSR MAC CE.

In some embodiment, the baseline BSR MAC CE above is named as the first/primary BSR MAC CE, and the supplement BSR MAC CE above is named as the second/secondary BSR MAC CE. The second/secondary BSR MAC CE may follow or precede the first/primary BSR MAC CE. The buffer size value is reported jointly by the first BSR MAC CE and the second/secondary BSR MAC CE. Whether the second/secondary BSR MAC CE can be reported is controlled by a report indication and/or a quantization error threshold configured by the network. The UE includes/sends the second/secondary BSR (only) if the report indication is configured by the network and/or (only) if the quantization error (of information in the BSR) is larger than the quantization threshold configured by the network.

### Time Information MAC CE

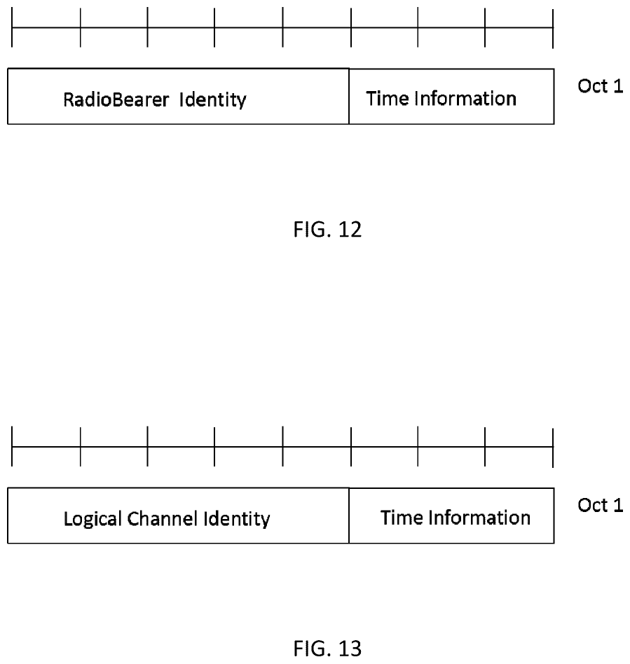

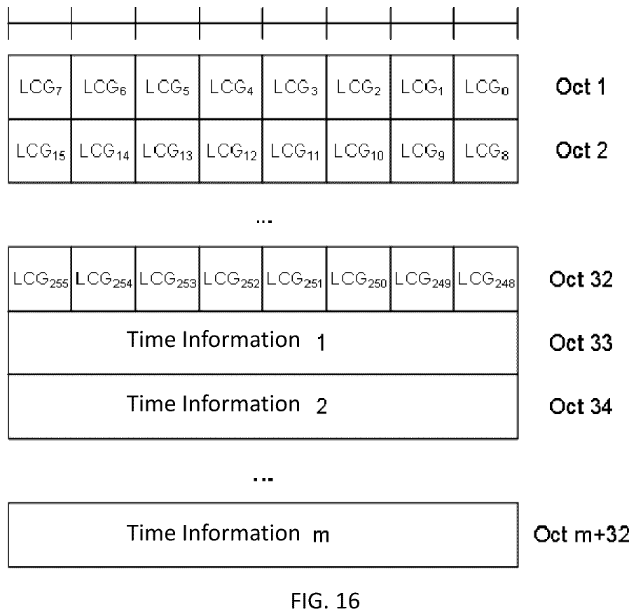

FIGS. 11 to 17 show schematic diagrams of time information MAC CEs according to embodiments of the present disclosure. Each of the time information MAC CE may follow or precede a BSR MAC CE (e.g., that shown in FIG. 3, 4, 7 or 9) or a Supplemental BSR MAC CE (e.g., that shown in FIG. 2, 6, 8 or 10), to indicate the time information related to the Buffer Size indicated in the BSR MAC CE is cached in UE. For example, the time information includes at least one of: elapsed time since the packet(s) arrives at UE PDCP or PDCP upper SAP; the remaining time before the elapsed time since the packet(s) arrives at UE PDCP or PDCP upper SAP reaches the (AN) Packet delay budget; the remaining time before the packet discardTimer expires; the arriving time that the packet(s) arrives at UE PDCP or PDCP upper SAP; an immediate scheduling indication indicates whether the PDU set(s) corresponding to the buffer size should be scheduled or transmitted immediately. a scheduling priority indication indicates whether the PDU set(s) corresponding to the buffer size should be scheduled or transmitted with the indicated priority.

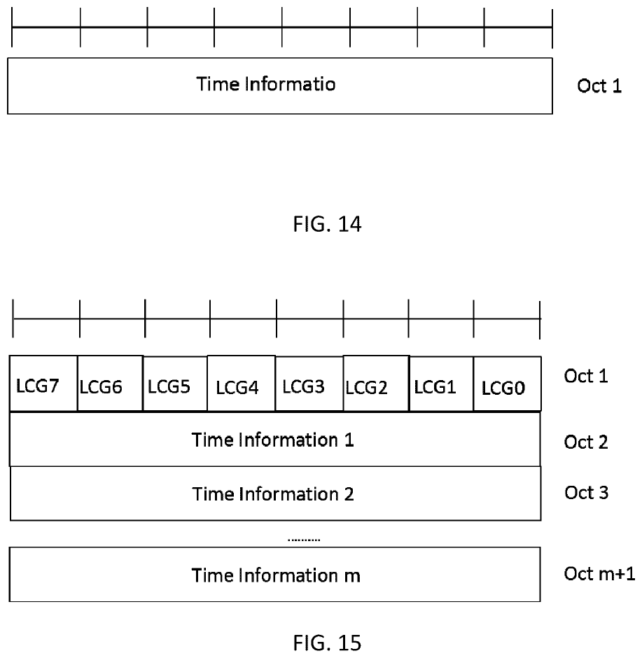

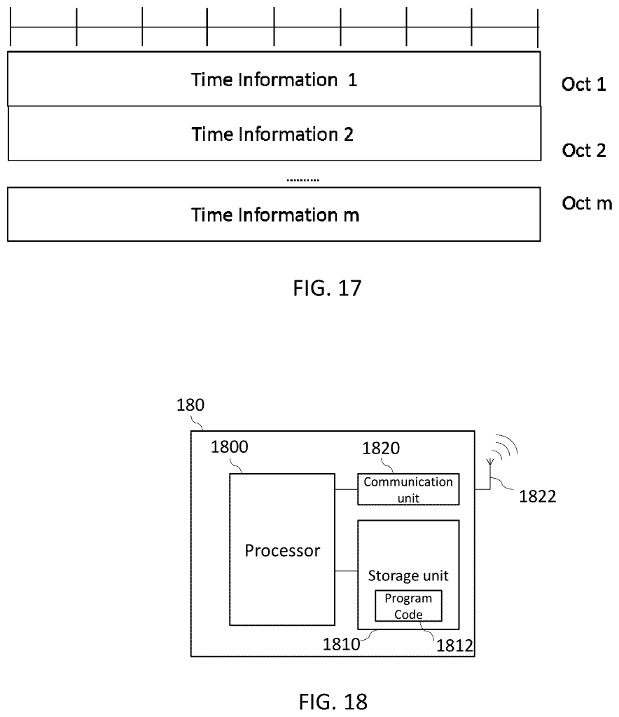

In an embodiment of the time information MAC CE not comprising LCG ID, Logic Channel Identity or RadioBearer Identity (e.g., FIG. 14 or 17), the identity in the preceding or following BSR MAC CE is reused for the time information MAC CE. For example, the time information in the time information MAC CE and the related buffer size in the BSR MAC CE corresponds to the same identity.

In an embodiment of the LCG ID, Logical Channel Identity or RadioBearer Identity being included in the time information MAC CE (e.g., FIG. 11, 12, 13, 15 or 16, the time information in the time information MAC CE and the buffer size in the preceding or following BSR MAC CE are correlated by the identity. For instance, the time information of an identity in the time information MAC CE corresponds to the buffer size of the same identity in the BSR MAC CE.

In an embodiment, the time information MAC CE is identified by a pre-defined UL LC ID in MAC subheader.

In an embodiment, before the UE sends the time information MAC CE, the UE receives, from the gNB, an indication on whether the gNB supports the time information MAC CE. The gNB may send the indication over a SIB or an RRC dedicated signaling per LCG, Per logical channel, per RLC configuration or per DRB.

In an embodiment, if only an immediate scheduling indication is used to indicate whether the PDU set(s) corresponding to the buffer size should be scheduled or transmitted immediately, a MAC CE with zero bit can be used (e.g., indicate using only MAC subheader with a pre-defined LC ID and no related MAC CE.)

Note that the bit number of each field in the MAC CE is only for illustrations and can be less or more. In addition, the number of oct is also for exemplary purpose and less or more oct may be used per MAC CE.

FIG. 18 relates to a schematic diagram of a wireless terminal 180 according to an embodiment of the present disclosure. The wireless terminal 180 may be a user equipment (UE), a mobile phone, a laptop, a tablet computer, an electronic book or a portable computer system and is not limited herein. The wireless terminal 180 may include a processor 1800 such as a microprocessor or Application Specific Integrated Circuit (ASIC), a storage unit 1810 and a communication unit 1820. The storage unit 1810 may be any data storage device that stores a program code 1812, which is accessed and executed by the processor 1800. Embodiments of the storage unit 1810 include but are not limited to a subscriber identity module (SIM), read-only memory (ROM), flash memory, random-access memory (RAM), hard-disk, and optical data storage device. The communication unit 1820 may a transceiver and is used to transmit and receive signals (e.g. messages or packets) according to processing results of the processor 1800. In an embodiment, the communication unit 1820 transmits and receives the signals via at least one antenna 1822 shown in FIG. 18.

In an embodiment, the storage unit 1810 and the program code 1812 may be omitted and the processor 1800 may include a storage unit with stored program code.

The processor 1800 may implement any one of the steps in exemplified embodiments on the wireless terminal 180, e.g., by executing the program code 1812.

The communication unit 1820 may be a transceiver. The communication unit 1820 may as an alternative or in addition be combining a transmitting unit and a receiving unit configured to transmit and to receive, respectively, signals to and from a wireless network node (e.g. a base station).

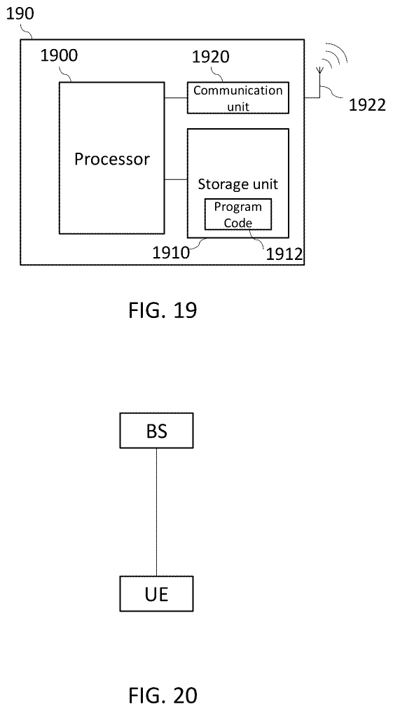

FIG. 19 relates to a schematic diagram of a wireless network node 190 according to an embodiment of the present disclosure. The wireless network node 190 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 190 may comprise (perform) at least one network function such as an access and mobility management function (AMF), a session management function (SMF), a user place function (UPF), a policy control function (PCF), an application function (AF), etc. The wireless network node 190 may include a processor 1900 such as a microprocessor or ASIC, a storage unit 1910 and a communication unit 1920. The storage unit 1910 may be any data storage device that stores a program code 1912, which is accessed and executed by the processor 1900. Examples of the storage unit 1910 include but are not limited to a SIM, ROM, flash memory, RAM, hard-disk, and optical data storage device. The communication unit 1920 may be a transceiver and is used to transmit and receive signals (e.g. messages or packets) according to processing results of the processor 1900. In an example, the communication unit 1920 transmits and receives the signals via at least one antenna 1922 shown in FIG. 19.

In an embodiment, the storage unit 1910 and the program code 1912 may be omitted. The processor 1900 may include a storage unit with stored program code.

The processor 1900 may implement any steps described in exemplified embodiments on the wireless network node 190, e.g., via executing the program code 1912.

The communication unit 1920 may be a transceiver. The communication unit 1920 may as an alternative or in addition be combining a transmitting unit and a receiving unit configured to transmit and to receive, respectively, signals to and from a wireless terminal (e.g. a user equipment or another wireless network node).

FIG. 20 shows a schematic diagram of a wireless communication system according to an embodiment of the present disclosure. In the wireless communication system, a UE may report its buffer status to the BS. For example, the UE may transmits a baseline BSR with a supplemental BSR to the BS, to report the buffer status. As an alternative of in addition, the UE may transmits a dynamic BSR to the BS, to report the buffer status. The detail of the UE reporting the buffer status can be referred to the embodiments of the present disclosure.

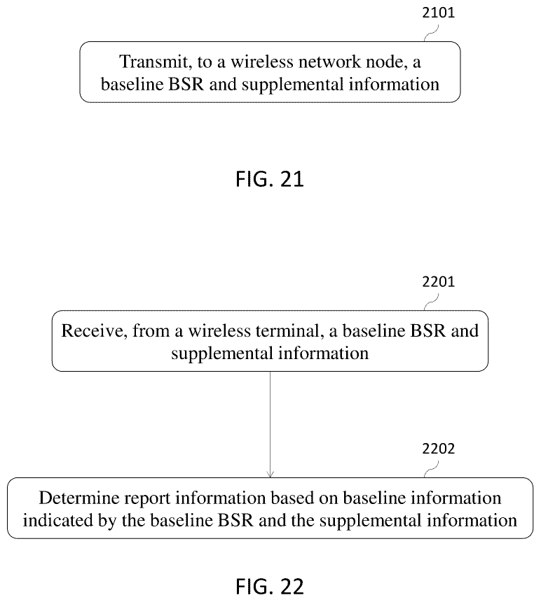

FIG. 21 shows a flowchart of a method according to an embodiment of the present disclosure. The method shown in FIG. 21 may be used in a wireless terminal (e.g., UE) and comprises the following step:

Step 2101: Transmit, to a wireless network node, a baseline BSR and supplemental information.

In FIG. 21, the wireless terminal transmits a baseline BSR and supplemental information to a wireless network node. In this embodiment, the report information reported by the BSR is determined based on baseline information indicated by the baseline BSR and the supplemental information.

In an embodiment, the supplemental information is (immediately) preceding or following the baseline BSR.

In an embodiment, the supplement information comprises at least one of supplemental buffer size information associated with a baseline buffer size indicated by the baseline BSR or supplemental time information associated with baseline time information indicated by the baseline BSR. Note that the baseline time information is associated with a period of the baseline buffer size being cached in the wireless terminal. That is the supplement information comprises at least one of the supplemental BSR or supplemental time information in the aforementioned embodiments. In other words, the report information based on the baseline information and supplemental information may comprise at least one of the buffer size or the time information of the buffer size being cached in the wireless terminal.

In an embodiment, the supplemental information shares at least one LC ID or at least one LCG ID of the baseline BSR. That is, the supplemental information may not comprise the LC ID and/or the LCG ID.

In an embodiment, the report information is determined to be equal to a sum of the baseline information and the supplemental information. In an embodiment, the report information may refer to the buffer size. That is, in this embodiment, the baseline information indicated by the baseline BSR is a baseline buffer size for a LC ID or a LCG ID and the supplemental information is a supplemental buffer size for the LC ID or the LCG ID. Furthermore, the baseline information may be a minimum value of a baseline information range corresponding to a baseline information index indicated by the baseline BSR for the LC ID or the LCG ID.

In an embodiment, the report information is determined to be equal to a difference between the baseline information and the supplemental information. In an embodiment, the report information may refer to the buffer size. That is, in this embodiment, the baseline information indicated by the baseline BSR is a baseline buffer size for a LC ID or a LCG ID and the supplemental information is a supplemental buffer size for the LC ID or the LCG ID. Moreover, the baseline information may be a maximum value of a baseline information range corresponding to a baseline information index indicated by the baseline BSR for the LC ID or the LCG ID.

In an embodiment, the supplemental information is determined based on a result of a function of a supplemental information index and a supplemental information value step (i.e., function (supplemental information index, supplemental information value step)).

In an embodiment, the function of the supplemental information index and the supplemental information value step is:
supplemental information index×supplemental information value step, or
supplemental information value step to the power of supplemental information index.

In an embodiment, the supplemental indicates the supplemental information index. In this embodiment, the supplemental information value step may be determined based on a baseline information range indicated by a baseline information index in the baseline BSR and a number of values corresponding to the supplemental information.

In an embodiment, the supplemental information indicates the supplemental information index and the supplemental information value step. In this embodiment, the supplemental information is equal to a smaller value between:
the function of the supplemental information index and the supplemental information value step, and
a difference between a maximal value of the baseline information indicated by a baseline information index in the baseline BSR and a minimum value of the baseline information indicated by the baseline information index in the baseline BSR.

In an embodiment, the baseline BSR is one of a Short BSR, a Short Truncated BSR, an Extended Short BSR, an Extended Short Truncated BSR, a Long BSR, a Long Truncated BSR, a Pre-emptive BSR, an Extended Long BSR, an Extended Long Truncated BSR, or an Extended Pre-emptive BSR.

In an embodiment, the wireless terminal receives an indication associated with supporting or activating the supplemental information from the wireless network node. The wireless terminal may receive the indication before transmitting the baseline BSR together with the corresponding supplemental information.

In an embodiment, the wireless terminal receives a quantization error threshold from the wireless network node. The wireless terminal may transmit the baseline BSR together with the corresponding supplemental information if (determining) an quantization error of the report information exceeds the quantization error threshold.

FIG. 22 shows a flowchart of a method according to an embodiment of the present disclosure. The method shown in FIG. 22 may be used in a wireless network node (e.g., BS) and comprises the following steps:

Step 2201: Receive, from a wireless terminal, a baseline BSR and supplemental information.

Step 2202: Determine report information based on baseline information indicated by the baseline BSR and the supplemental information.

In FIG. 22, the wireless network node receives a baseline BSR and supplemental information from a wireless terminal (e.g., UE). The wireless network node determines report information based on baseline information indicated by the baseline BSR and the supplemental information.

In an embodiment, the supplemental information is (immediately) preceding or following the baseline BSR.

In an embodiment, the supplement information comprises at least one of supplemental buffer size information associated with a baseline buffer size indicated by the baseline BSR or supplemental time information associated with baseline time information indicated by the baseline BSR. Note that the baseline time information is associated with a period of the baseline buffer size being cached in the wireless terminal. That is the supplement information comprises at least one of the supplemental BSR or supplemental time information in the aforementioned embodiments. In other words, the report information based on the baseline information and supplemental information may comprise at least one of the buffer size or the time information of the buffer size being cached in the wireless terminal.

In an embodiment, the supplemental information shares at least one LC ID or at least one LCG ID of the baseline BSR. That is, the supplemental information may not comprise the LC ID and/or the LCG ID.

In an embodiment, the report information is determined to be equal to a sum of the baseline information and the supplemental information. In an embodiment, the report information may refer to the buffer size. That is, in this embodiment, the baseline information indicated by the baseline BSR is a baseline buffer size for a LC ID or a LCG ID and the supplemental information is a supplemental buffer size for the LC ID or the LCG ID. Furthermore, the baseline information may be a minimum value of a baseline information range corresponding to a baseline information index indicated by the baseline BSR for the LC ID or the LCG ID.

In an embodiment, the report information is determined to be equal to a difference between the baseline information and the supplemental information. In an embodiment, the report information may refer to the buffer size. That is, in this embodiment, the baseline information indicated by the baseline BSR is a baseline buffer size for a LC ID or a LCG ID and the supplemental information is a supplemental buffer size for the LC ID or the LCG ID. Moreover, the baseline information may be a maximum value of a baseline information range corresponding to a baseline information index indicated by the baseline BSR for the LC ID or the LCG ID.

In an embodiment, the supplemental information is determined based on a result of a function of a supplemental information index and a supplemental information value step (i.e., function (supplemental information index, supplemental information value step)).

In an embodiment, the function of the supplemental information index and the supplemental information value step is:
supplemental information index×supplemental information value step, or
supplemental information value step to the power of supplemental information index.

In an embodiment, the supplemental indicates the supplemental information index. In this embodiment, the supplemental information value step may be determined based on a baseline information range indicated by a baseline information index in the baseline BSR and a number of values corresponding to the supplemental information.

In an embodiment, the supplemental information indicates the supplemental information index and the supplemental information value step. In this embodiment, the supplemental information is equal to a smaller value between:
the function of the supplemental information index and the supplemental information value step, and
a difference between a maximal value of the baseline information indicated by a baseline information index in the baseline BSR and a minimum value of the baseline information indicated by the baseline information index in the baseline BSR.

In an embodiment, the baseline BSR is one of a Short BSR, a Short Truncated BSR, an Extended Short BSR, an Extended Short Truncated BSR, a Long BSR, a Long Truncated BSR, a Pre-emptive BSR, an Extended Long BSR, an Extended Long Truncated BSR, or an Extended Pre-emptive BSR.

In an embodiment, the wireless network node transmits an indication associated with supporting or activating the supplemental information to the wireless terminal. The wireless terminal may transmits the baseline BSR together with the corresponding supplemental information after receiving the indication.

In an embodiment, the wireless network node transmits a quantization error threshold to the wireless terminal. The quantization error threshold is associated with a case/condition of the wireless terminal transmitting the baseline BSR together with the corresponding supplemental information. For example, the wireless terminal may transmit the baseline BSR together with the corresponding supplemental information if (determining) an quantization error of the report information exceeds the quantization error threshold.

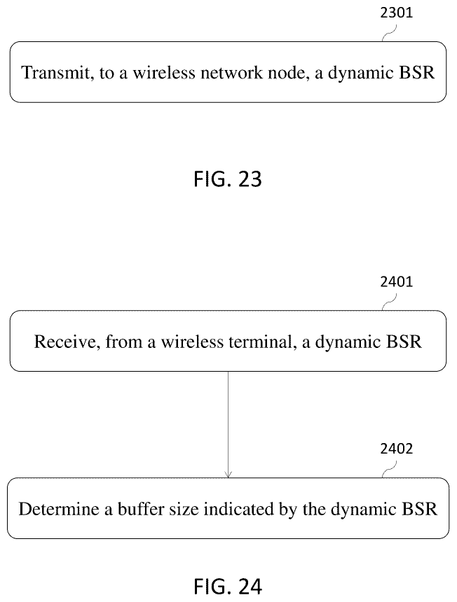

FIG. 23 shows a flowchart of a method according to an embodiment of the present disclosure. The method shown in FIG. 23 may be used in a wireless terminal (e.g., UE) and comprises the following step:

Step 2301: Transmit, to a wireless network node, a dynamic BSR.

In FIG. 23, the wireless terminal transmits a dynamic BSR to a wireless network node (e.g., BS). The buffer size reported by the dynamic BSR is determined by/based on:

buffer size=minimal buffer size value+buffer size value step size×buffer size value sequence number.

In an embodiment, the dynamic BSR comprises at least one of the minimal buffer size value, the buffer size value step size or the buffer size value sequence number.

In an embodiment, at least one of the minimal buffer size value, the buffer size value step size or the buffer size value sequence number may be predefined or configured via another message (e.g., SIB or dedicated RRC signaling).

In an embodiment, the dynamic BSR further comprises an indication of whether the dynamic BSR comprises a time information field.

In an embodiment, the time information field indicates a time/period of the buffer size is cached in the wireless terminal.

FIG. 24 shows a flowchart of a method according to an embodiment of the present disclosure. The method shown in FIG. 24 may be used in a wireless network node (e.g., BS) and comprises the following steps:
Step 2401: Receive, from a wireless terminal, a dynamic BSR.
Step 2402: Determine a buffer size indicated by the dynamic BSR.

In FIG. 24, the wireless network node receives a dynamic BSR from a wireless terminal (e.g., UE) and determines a buffer size indicated by the dynamic BSR (based on the dynamic BSR). In this embodiment, the buffer size indicated by the dynamic BSR is determine by/based on:

buffer size=minimal buffer size value+buffer size value step size×buffer size value sequence number.

In an embodiment, the dynamic BSR comprises at least one of the minimal buffer size value, the buffer size value step size or the buffer size value sequence number.

In an embodiment, at least one of the minimal buffer size value, the buffer size value step size or the buffer size value sequence number may be predefined or configured via another message (e.g., SIB or dedicated RRC signaling).

In an embodiment, the dynamic BSR further comprises an indication of whether the dynamic BSR comprises a time information field.

In an embodiment, the time information field indicates a time/period of the buffer size is cached in the wireless terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

I/We claim:

1. A wireless communication method for use in a wireless terminal, the method comprising:
transmitting, to a wireless network node, a baseline buffer size report (BSR) and supplemental information,
wherein report information reported by the BSR is determined based on baseline information indicated by the baseline BSR and the supplemental information.

2. The wireless communication method of claim 1, wherein the supplemental information is preceding or following the baseline BSR,
wherein the supplement information comprises at least one of supplemental buffer size information associated with a baseline buffer size indicated by the baseline BSR or supplemental time information associated with baseline time information indicated by the baseline BSR, wherein the baseline time information is associated with a period of the baseline buffer size being cached in the wireless terminal, and
wherein the supplemental information shares at least one logic channel identifier or at least one logic channel group identifier of the baseline BSR.

3. The wireless communication method of claim 1, wherein the report information is determined to be equal to a sum of the baseline information and the supplemental information, wherein the report information is a buffer size,
and wherein the baseline information is a minimum value of a baseline information range corresponding to a baseline information index indicated by the baseline BSR.

4. The wireless communication method of claim 1, wherein the report information is determined to be equal to a difference between the baseline information and the supplemental information, wherein the report information is a buffer size;
and wherein the baseline information is a maximum value of a baseline information range corresponding to a baseline information index indicated by the baseline BSR.

5. The wireless communication method of claim 3, wherein the supplemental information is determined based on a result of a function of a supplemental information index and a supplemental information value step.

6. The wireless communication method of claim 5, wherein the function of the supplemental information index and the supplemental information value step is:
(supplemental information index×supplemental information value step), or
(supplemental information value step to the power of supplemental information index).

7. The wireless communication method of claim 5, wherein the supplemental information indicates the supplemental information index, and
wherein the supplemental information value step is determined based on the baseline information range indicated by the baseline information index in the baseline BSR and a number of values corresponding to the supplemental information.

8. The wireless communication method of claim 5, wherein the supplemental information indicates the supplemental information index and the supplemental information value step,
wherein the supplemental information is equal to a smaller value between:
the function of the supplemental information index and the supplemental information value step, and
a difference between a maximal value of the baseline information indicated by a baseline information index in the baseline BSR and a minimum value of the baseline information indicated by the baseline information index in the baseline BSR.

9. The wireless communication method of claim 1, wherein the baseline BSR is one of a Short BSR, a Short Truncated BSR, an Extended Short BSR, an Extended Short Truncated BSR, a Long BSR, a Long Truncated BSR, a Pre-emptive BSR, an Extended Long BSR, an Extended Long Truncated BSR, or an Extended Pre-emptive BSR.

10. The wireless communication method of claim 1, further comprising:
receiving, from the wireless network node, an indication associated with supporting or activating the supplemental information; or
receiving, from the wireless network node, a quantization error threshold, wherein the supplemental information is transmitted if a quantization error associated with the report information is greater than the quantization error threshold.

11. A wireless communication method for use in a wireless network node, the method comprising:
receiving, from a wireless terminal, a baseline buffer size report (BSR) and supplemental information, and
determining report information based on baseline information indicated by the baseline BSR and the supplemental information.

12. The wireless communication method of claim 11, wherein the supplement information comprises at least one of supplemental buffer size information associated with a baseline buffer size indicated by the baseline BSR or supplemental time information associated with baseline time information indicated by the baseline BSR, wherein the baseline time information is associated with a period of the baseline buffer size being cached in the wireless terminal, and
wherein the supplemental information shares at least one logic channel identifier or at least one logic channel group identifier of the baseline BSR.

13. The wireless communication method of claim 11, wherein the determining the report information based on the baseline information indicated by the baseline BSR and the supplemental information comprises:
determining a sum of the baseline information and the supplemental information as the report information,
wherein the report information is a buffer size,
wherein the baseline information is a minimum value of a baseline information range corresponding to a baseline information index indicated by the baseline BSR.

14. The wireless communication method of claim 11, wherein the determining the report information based on the baseline information indicated by the baseline BSR and the supplemental information comprises:
determining a difference between the baseline information and the supplemental information as the report information,
wherein the report information is a buffer size, and
wherein the baseline information is a maximum value of a baseline information range corresponding to a baseline information index indicated by the baseline BSR.

15. The wireless communication method of claim 12, wherein the supplemental information is determined based on a result of a function of a supplemental information index and a supplemental information value step, and
wherein the function of the supplemental information index and the supplemental information value step is:
(supplemental information index×supplemental information value step), or
(supplemental information value step to the power of supplemental information index).

16. The wireless communication method of claim 15, wherein the supplemental BSR indicates the supplemental BSR information index;
wherein the supplemental information value step is determined based on a baseline information range indicated by a baseline information index in the baseline BSR and a number of values corresponding to the supplemental information.

17. The wireless communication method of claim 15, wherein the supplemental information indicates the supplemental information index and the supplemental information value step;
wherein the supplemental information is equal to a smaller value between:
the function of the supplemental information index and the supplemental information value step, and
a difference between a maximal value of the baseline information indicated by a baseline information index in the baseline BSR and a minimum value of the baseline information indicated by the baseline information index in the baseline BSR.

18. The wireless communication method of claim 11, wherein the baseline BSR is one of a Short BSR, a Short Truncated BSR, an Extended Short BSR, an Extended Short Truncated BSR, a Long BSR, a Long Truncated BSR, a Pre-emptive BSR, an Extended Long BSR, an Extended Long Truncated BSR, or an Extended Pre-emptive BSR, wherein the wireless communication method further comprises:
transmitting, to the wireless terminal, an indication associated with supporting or activating the supplemental information; or
transmitting, to the wireless terminal, a quantization error threshold associated with transmitting the supplemental information.

19. A wireless terminal, comprising:
a communication unit, configured to transmit, to a wireless network node, a baseline buffer size report (BSR) and supplemental information,
wherein report information reported by the BSR is determined based on baseline information indicated by the baseline BSR and the supplemental information.

20. A wireless network node, comprising:
a communication unit, configured to receive, from a wireless terminal, a baseline buffer size report (BSR) and supplemental information, and
a processor, configured to:
receive, from a wireless terminal, a baseline buffer size report (BSR) and supplemental information, and
determine report information based on baseline information indicated by the baseline BSR and the supplemental information.
